(19) United States
(12) Patent Application Publication
(10) Pub. No.: US 2016/0360268 A1
(43) Pub. Date: Dec. 8, 2016

(54) EYE PROTECTION METHOD BASED ON SMART TV AND SMART TV

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Junjie ZHAO, Beijing (CN)

(73) Assignees: LE HOLDINGS (BEIJING) CO., LTD., Beijing (CN); LE SHI ZHI XIN ELECTRONIC TECHNOLOGY (TIANJIN) LIM ITED, Beijing (CN)

(21) Appl. No.: 15/239,774

(22) Filed: Aug. 17, 2016

Related U.S. Application Data
(63) Continuation of application No. PCT/CN2015/081333, filed on Jun. 12, 2015.

(30) Foreign Application Priority Data
Jun. 13, 2014 (CN) 201410264367.4

(51) Int. Cl. H04N 21/442; G09B 19/00; G09B 5/02; G06F 3/01

(52) U.S. Cl. CPC H04N 21/44218; G06F 3/013; G09B 19/003; G09B 5/02

(57) ABSTRACT

An eye protection method based on smart television, and a smart television, the method comprising: when reaching a preset eye protection point in time, determining, according to the current operation information of a smart television, whether the smart television is suitable to protect the eyes at the eye protection point in time; and if yes, then protecting the eyes and suspending the current operation. According to actual conditions, presetting an eye protection point in time, and when reaching the preset eye protection point in time, further determining, according to the current operation information of the smart television, whether the smart television is suitable to protect eyes at the eye protection point in time, and then protecting eyes at a point in time suitable for eye protection. Therefore, the present invention determines whether the smart television is suitable to protect eyes according to the current operation information of the smart television.

### CROSS-REFERENCE TO RELATED APPLICATIONS

This application is based upon Chinese Patent Application 201410264367.4, titled “Eye Protection Method Based On Smart TV And Smart TV” filed on Jun. 13, 2014, the entire contents of which are incorporated herein by reference.

### TECHNICAL FIELD

The present disclosure relates to the technologies of a smart TV, and more particularly, to an eye protection method based on smart TV and a smart TV.

### BACKGROUND

In recent years, smart TV has been developed like a raging fire. More and more technologies have been applied and implemented in TV. In this way, intelligentization is doomed to become the development trend of the TV industry in several future years. An eye protection function is integrated in the smart TV. Eye protection is performed by a TV clock at a fixed period according to a preset time period to protect the eye fatigue during the course of watching TV. However, operation inconvenience may be caused by performing the eye protection at the fixed period in the prior art.

### SUMMARY

The embodiments of the present disclosure provide an eye protection method based on smart TV and a smart TV, so as to solve a problem of inconvenience in operation caused by eye protection at a fixed period in the prior art.

The embodiments of the present disclosure provides an eye protection method based on a smart TV, including: determining whether the smart TV is suitable to protect eyes at the eye protection point in time according to the current operation information of the smart TV when reaching a preset eye protection point in time; and then protecting the eyes and suspending the current operation when the smart TV is suitable to protect the eyes at the eye protection point in time.

The embodiments of the present disclosure provides a smart TV, including: a determination unit, configured to determine whether the smart TV is suitable to protect eyes at the eye protection point in time according to the current operation information of the smart TV when reaching a preset eye protection point in time; and an eye protection unit, configured to protect the eyes and suspend the current operation when the smart TV is suitable to protect the eyes at the eye protection point in time.

According to the eye protection method based on the smart TV and the smart TV provided by the embodiments of the present disclosure, the eye protection point in time is preset according to the actual conditions. When reaching the preset eye protection point in time, whether it is suitable to protect the eyes at the eye protection point in time needs to be preferably judged according to the current operation information of the smart TV, and the eyes are protected at the point in time when it is suitable to protect the eyes. Therefore, the inconvenience caused for the current operation of the smart TV when protecting the eyes is avoided by judging whether protecting the eyes according to the current operation information of the smart TV in the present disclosure.

### BRIEF DESCRIPTION OF THE DRAWINGS

For a better understanding of the aforementioned embodiments of the invention as well as additional embodiments thereof, reference should be made to the Detailed Description below, in conjunction with the following drawings in which like reference numerals refer to corresponding parts throughout the figures.

FIG. 1 is a flow chart of an eye protection method embodiment based on a smart TV according to the present disclosure;

FIG. 2 is a flow chart of an eye protection method embodiment based on a smart TV according to the present disclosure;

FIG. 3 is a flow chart of an eye protection method embodiment based on a smart TV according to the present disclosure;

FIG. 4 is a flow chart of an eye protection method embodiment based on a smart TV according to the present disclosure;

FIG. 5 is a structure diagram of a smart TV embodiment according to the present disclosure; and

FIG. 6 is a structure diagram of a smart TV embodiment according to the present disclosure.

FIG. 7 is a structure diagram of a smart TV embodiment according to the present disclosure.

### DETAILED DESCRIPTION

In order to make the objectives, technical solutions and advantages of the embodiments of the present disclosure more clearly, the technical solutions in the embodiments of the preset disclosure will be described clearly and completely with reference to the drawings in the embodiments of the present disclosure. Apparently, the embodiments described are partial embodiments of the present disclosure, rather than all embodiments. Other embodiments figured out by those having ordinary skills in the art on the basis of the embodiments of the present disclosure without going through creative efforts shall all within the protection of the present disclosure.

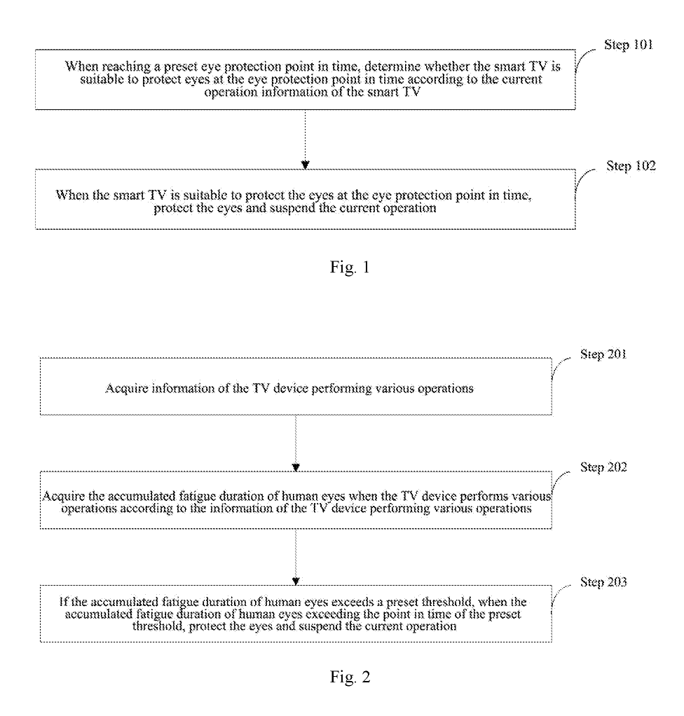

The embodiment of the present disclosure provides an eye protection method based on a smart TV as shown in FIG. 1. The method may include the following steps.

In step 101, when reaching a preset eye protection point in time, whether the smart TV is suitable to protect the eyes at the eye protection point in time is judged according to the current operation information of the smart TV.

In step 102, when the smart TV is suitable to protect the eyes at the eye protection point in time, the eyes are protected and the current operation is suspended.

According to the solutions above, the eye protection point in time is preset according to the actual conditions. When reaching the preset eye protection point in time, whether it is suitable to protect the eyes at the eye protection point in time needs to be preferably judged according to the current operation information of the smart TV, and the eyes are protected at the point in time when it is suitable to protect the eyes. Therefore, the inconvenience caused for the current operation of the smart TV when protecting the eyes is avoided by judging whether protecting the eyes according to the current operation information of the smart TV in the present disclosure.

Another embodiment of the present disclosure further provides an eye protection method based on a smart TV as shown in FIG. 2. The method may include the following steps.

In step 201, information of the smart TV performing various operations is acquired.

In step 202, the accumulated fatigue duration of human eyes when the smart TV performs various operations is acquired according to the information of the smart TV performing various operations.

In step 203, if the accumulated fatigue duration of human eyes exceeds a preset threshold, the accumulated fatigue duration of human eyes exceeds the point in time of the preset threshold, the eyes are protected and the current operation is suspended.

According to the solutions above, the accumulated fatigue duration of human eyes when the smart TV performs various operations is acquired according to the information of various operations of the smart TV in the actual conditions. When the accumulated fatigue duration of human eyes exceeds the preset threshold, it illustrates that the human eye fatigue achieves a certain extent under which it is the best point in time to protect the eyes, so as to avoid causing inconvenience for the current operation of the smart TV when protecting the eyes.

The technical solutions in the embodiments of the present disclosure will be described clearly and completely with reference to the drawings in the embodiments of the present disclosure.

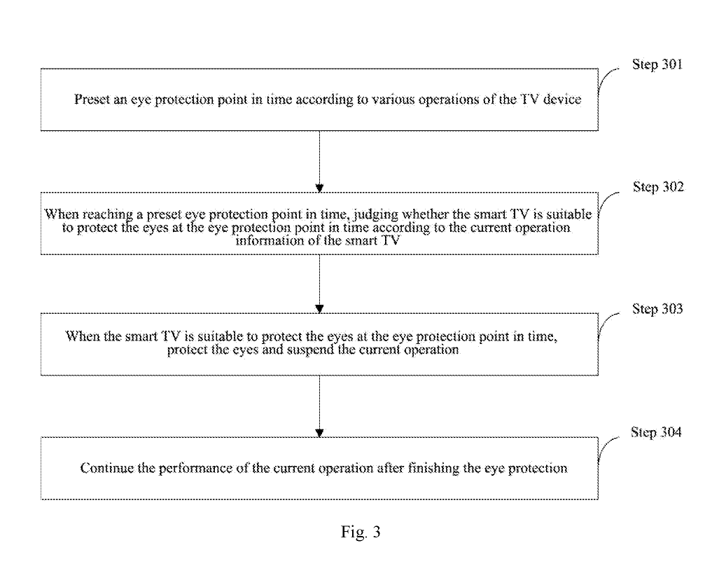

The embodiment of the present disclosure provides an eye protection method based on a smart TV as shown in FIG. 3. The method may include the following steps.

In step 301, an eye protection point in time is preset according to various operations of the smart TV.

In the embodiment, the set eye protection point in time is a preset point in time or the point in time that the accumulated fatigue duration of human eyes when the smart TV performs various operations exceeds a preset threshold.

Various operations in the smart TV may include: watching videos, playing games, browsing webpage, and viewing pictures, etc. According to various operations in the smart TV, different eye protection points in time may be preset, and the accumulated fatigue duration of human eyes during various operations is a product of the duration when the smart TV performs various operations multiplying by fatigue factors of various operations.

For instance, the preset threshold 60 is taken for example. Watching videos is at a normal degree, that it, the fatigue factor is 1. The eye protection point in time may be configured to reach once eye protection point in time every one hour from the initial watching point in time if the accumulated fatigue duration of human eyes of the smart TV is 60 min*1 exceeding the threshold 60. When playing games, game animations in the screen may need to be stared at all the time, so that the fatigue factor is higher. Taking the fatigue factor 1.3 for example, the eye protection point in time may be configured to reach once eye protection point in time every 46 min from the initial watching point in time if the accumulated fatigue duration of human eyes of the smart TV is 46 min*1.3. Or, the videos are watched for 30 min firstly, and then the games are played for 24 min. In this way, the accumulated fatigue duration of human eyes is 30 min*1+24 min*1.3, then the accumulated fatigue duration of human eyes exceeds the threshold 60, so that the eyes are protected.

Therefore, the different eye protection points in time are set by different operations in the smart TV, so as to be able to implement the more correct and scientific eye protection according to the actual conditions.

In the embodiment of the present disclosure, the total time of opening the human eyes is recorded by means of an external camera on the smart TV to estimate the degree of fatigue of human eyes.

In one embodiment of the present disclosure, the time of one day may be further performed time period division to implement the multi-mode eye protection.

For instance, the time period divided from the time of one day may include: forenoon, afternoon, nightfall, late night and so on.

According to the examples above, the eye protection mode at forenoon may be as follows: when watching videos, the eye protection point in time is configured to enable the smart TV to reach once eye protection point in time every one hour from the initial watching point in time. The eye protection mode in the night may be as follows: when watching videos, the eye protection point in time is configured to enable the smart TV to reach once eye protection point in time every forty minutes from the initial watching point in time.

The different eye protection points in time in different modes are set according to the above solution.

In step 302, when reaching a preset eye protection point in time, whether the smart TV is suitable to protect the eyes at the eye protection point in time is judged according to the current operation information of the smart TV.

In step 303, when the smart TV is suitable to protect the eyes at the eye protection point in time, the eyes are protected and the current operation is suspended.

During the course of various operations, the current operation information of the smart TV needs to be acquired when achieving the preset eye protection point in time.

In the embodiment, the current operation information may include: a running time of the current operation or a running time of the current operation when starting in a new round, a rest end time of the current operation or a rest end time of the current operation after starting in a new round.

In one embodiment, when the smart TV is not suitable to protect the eyes at the eye protection point in time, a point in time suitable for eye protection is acquired according to the current operation information of the smart TV, and the eyes are protected and the current operation is suspended at the point time suitable for eye protection.

For instance, when watching video, the total time of watching video is 125 min, and the preset eye protection time is 60 min. According to the acquired current operation information of the smart TV, the time starting watching the video is at 8:00 am. When the time duration for broadcasting the video is 60 min and the rest end time is 65 min, the preset eye protection point in time is achieved at this moment. Therefore, whether the smart TV is suitable to protect the eyes is judged at the eye protection point in time. As the video broadcast duration corresponding to the point in time is in the middle time period of the total time of the video, this moment is suitable to protect the eyes.

When the time duration for broadcasting the video is 120min and the rest end time is 5 min, the preset eye protection point in time is achieved at this moment. Therefore, whether the smart TV is suitable to protect the eyes is judged at the eye protection point in time. As the rest end time of the video is 5 min, there are only 5 minutes of video broadcast time after finishing. In this way, the eyes may be protected after finishing the video broadcasting.

For instance, when playing game, the game includes at least a level, the eyes are protected every 46 min. The preset eye protection point in time at the 46 min is achieved according to the initial time of playing game. It is known that the game is in the course of the current level game at this moment according to the acquired current operation information of the smart TV; therefore, the eyes need to be protected after finishing the current level.

In the embodiment of the preset disclosure, the smart TV and the cloud video server perform the interactive operation when protecting the eyes, so that the related eye protection content is pushed by the cloud video server.

The related eye protection content pushed by the cloud video server is selected by the smart TV, and a selection result is returned to the cloud video server, so that the cloud video server pushes the related eye protection contents pushed by the cloud video server and selected by the smart TV in the selection result via the cloud video server under a condition of the interactive operation between the smart TV and the cloud video server.

For instance, the step of performing the interactive operation between the smart TV and the cloud video server, so that the related eye protection content being pushed by the cloud video server may include: intelligently playing the music of eye exercises or playing teaching animation and other contents of the eye exercises. And the music name for selection may also be shown at this time. The related eye protection content pushed by the cloud video server is selected by the smart TV, and the selection result, for instance, the music name and the like, is returned to the cloud video server, so that the cloud video server pushes the related eye protection contents pushed by the cloud video server and selected by the smart TV in the selection result via the cloud video server under the condition of the interactive operation between the smart TV and the cloud video server. The related eye protection content is provided by the cloud video server and the selection result send by the intelligent TV is received by the cloud video server through the interactive operation between the smart TV and the cloud video server in the solution, so that the related eye protection content is rapid during the course of the later interactive operation between the smart TV and the cloud video server, which saves the time of the selection process.

Such contents like memo affairs and so on in the embodiment of the present disclosure may be performed according to the content preset by the user.

In step 304, the performance of the current operation is continued after finishing the eye protection.

As the operation is performed during the course of the current operation, the current operation is continued after finishing, so as to enable the eye protection not to affect the process of the current operation.

According to the solutions above, the eye protection point in time is preset according to the actual conditions. When reaching the preset eye protection point in time, whether it is suitable to protect the eyes at the eye protection point in time needs to be further judged according to the current operation information of the smart TV, and the eyes are protected at the point in time when it is suitable to protect the eyes. Therefore, the inconvenience caused for the current operation of the smart TV when protecting the eyes is avoided by judging whether protecting the eyes according to the current operation information of the smart TV in the present disclosure. The related eye protection content is provided by the cloud video server and the selection result send by the intelligent TV is received by the cloud video server through the interactive operation between the smart TV and the cloud video server, so that the related eye protection content is rapid during the course of the later interactive operation between the smart TV and the cloud video server, which saves the time of the selection process.

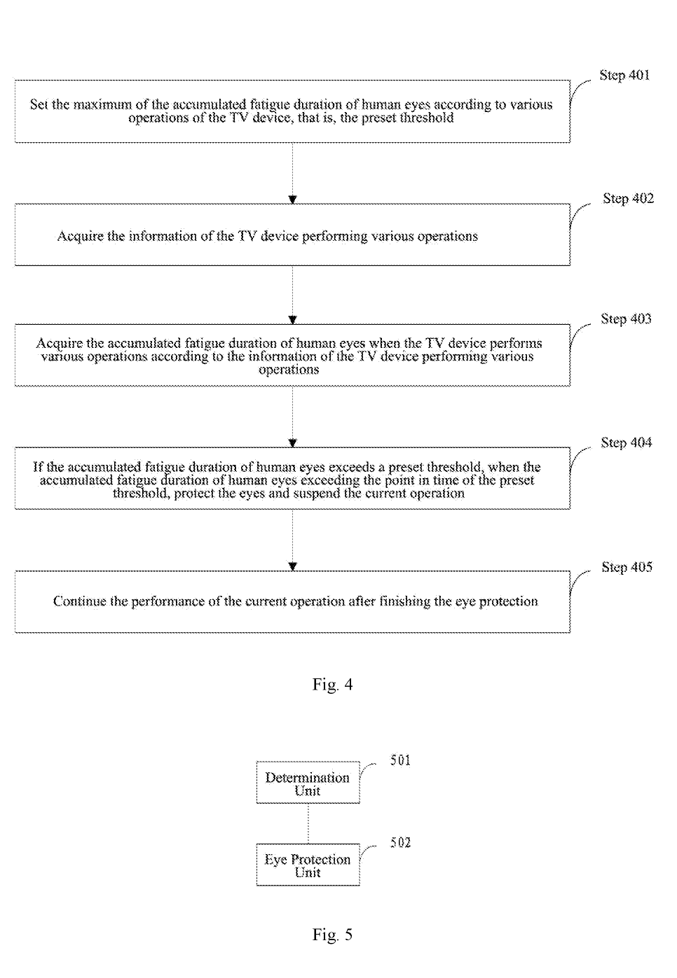

The embodiment of the present disclosure provides an eye protection method based on a smart TV as shown in FIG. 4. The method may include the following steps.

In step 401, the maximum of the accumulated fatigue duration of human eyes is set according to various operations of the smart TV, that is, the preset threshold.

In step 402, information of the smart TV performing various operations is acquired.

Various operations in the smart TV may include: watching videos, playing games, browsing webpage, and viewing pictures, etc. As various operations enable the degree of fatigue of human eyes to be different in the same time, the corresponding preset threshold needs to be set according to various operations in the smart TV.

In step 403, the accumulated fatigue duration of human eyes when the smart TV performs various operations is acquired according to the information of the smart TV performing various operations.

In the embodiment, the accumulated fatigue duration of human eyes of human eyes during various operations is a product of the duration when the smart TV performs various operations multiplying by fatigue factors of various operations.

For instance, the preset threshold 60 is taken for example. Watching videos is at a normal degree, that it, the fatigue factor is 1. The eye protection point in time may be configured to reach once eye protection point in time every one hour from the initial watching point in time if the accumulated fatigue duration of human eyes of the smart TV is 60 min*1 exceeding the threshold 60. When playing games, game animations in the screen may need to be stared at all the time, so that the fatigue factor is higher. Taking the fatigue factor 1.3 for example, the eye protection point in time may be configured to reach once eye protection point in time every 46 min from the initial watching point in time if the accumulated fatigue duration of human eyes of the smart TV is 46 min*1.3. Or, the videos are watched for 30 min firstly, and then the games are played for 24 min. In this way, the accumulated fatigue duration of human eyes is 30 min*1+24 min*1.3, then the accumulated fatigue duration of human eyes exceeds the threshold 60, so that the eyes are protected.

The different eye protection points in time are set by different operations in the smart TV, so as to be able to implement the more correct and scientific eye protection according to the actual conditions.

In the embodiment of the present disclosure, the total time of opening the human eyes is recorded by means of an external camera on the smart TV to estimate the degree of fatigue of human eyes.

In step 404, if the accumulated fatigue duration of human eyes exceeds a preset threshold, the accumulated fatigue duration of human eyes exceeds the point in time of the preset threshold, the eyes are protected and the current operation is suspended.

In one embodiment of the present disclosure, the time of one day may be further performed time period division to implement the multi-mode eye protection.

For instance, the time period divided from the time of one day may include: forenoon, afternoon, nightfall, late night and so on.

According to the examples above, the eye protection mode at forenoon may be as follows: when watching videos, the set accumulated fatigue duration of human eyes of eye protection is 60. The eyes are protected once by the smart TV when the accumulated fatigue duration of human eyes for watching every time reaches 60. The eye protection mode at late-night may be as follows: when watching videos, the set accumulated fatigue duration of human eyes of eye protection is 40. The eyes are protected once by the smart TV when the accumulated fatigue duration of human eyes for watching every time reaches 40.

Further, when the smart TV is not suitable to protect the eyes at the eye protection point in time, a point in time suitable for eye protection is acquired according to the current operation information of the smart TV, and the eyes are protected and the current operation is suspended at the point time suitable for eye protection.

It is more objective to determine by the set accumulated fatigue duration of human eyes of eye protection and the counted accumulated fatigue duration of human eyes for watching every time. However, the state of the current operation is also combined in the actual implementation.

For instance, when watching the video, the time duration for broadcasting the video is 45 min and the set accumulated fatigue duration of human eyes of eye protection is 40 min. When the accumulated fatigue duration of human eyes for watching this time reaches 40 m and the reset end time is 5 min. Whether the smart TV is suitable to protect the eyes is judged at the eye protection point in time according to the eye protection point in time reached at this moment. As the rest end time of the video is 5 min, there are only 5 minutes of video broadcast time after finishing. In this way, the eyes may be protected after finishing the video broadcasting.

For instance, when playing game, the game includes at least a level, and the level game duration is about 46 min. The set accumulated fatigue duration of human eyes of eye protection is 40 min. When reaching the 40th minute at present, it is known that the game is in the course of the current level game at this moment according to the acquired current operation information of the smart TV; therefore, the eyes need to be protected after finishing the current level.

In the embodiment of the preset disclosure, the smart TV and the cloud video server perform the interactive operation when protecting the eyes, so that the related eye protection content is pushed by the cloud video server.

The related eye protection content pushed by the cloud video server is selected by the smart TV, and a selection result is returned to the cloud video server, so that the cloud video server pushes the related eye protection contents pushed by the cloud video server and selected by the smart TV in the selection result via the cloud video server under the condition of the interactive operation between the smart TV and the cloud video server.

For instance, the step of performing the interactive operation between the smart TV and the cloud video server, so that the related eye protection content being pushed by the cloud video server may include: intelligently playing the music of eye exercises or playing teaching animation and other contents of the eye exercises. And the music name for selection may also be shown at this time. The related eye protection content pushed by the cloud video server is selected by the smart TV, and the selection result, for instance, the music name and the like, is returned to the cloud video server, so that the cloud video server pushes the related eye protection contents pushed by the cloud video server and selected by the smart TV in the selection result via the cloud video server under the condition of the interactive operation between the smart TV and the cloud video server. The related eye protection content is provided by the cloud video server and the selection result send by the intelligent TV is received by the cloud video server through the interactive operation between the smart TV and the cloud video server in the solution, so that the related eye protection content is rapid during the course of the later interactive operation between the smart TV and the cloud video server, which saves the time of the selection process.

Such contents like memos and so on in the embodiment of the present disclosure may be performed according to the content preset by the user.

In step 405, the performance of the current operation is continued after finishing the eye protection.

As the operation is performed during the course of the current operation, the current operation is continued after finishing, so as to enable the eye protection not to affect the process of the current operation.

According to the solutions above, the accumulated fatigue duration of human eyes when the smart TV performs various operations is acquired according to the information of various operations of the smart TV in the actual conditions. When the accumulated fatigue duration of human eyes exceeds the preset threshold, it illustrates that the human eye fatigue achieves a certain extent under which it is the best point in time to protect the eyes, so as to avoid causing inconvenience for the current operation of the smart TV when protecting the eyes.

As shown in FIG. 5, the embodiment of the present disclosure further provides a smart TV. The smart TV includes a determination unit 501 and an eye protection unit 502.

The determination unit 501 is configured to determine whether the smart TV is suitable to protect the eyes at the eye protection point in time according to the current operation information of the smart TV when reaching a preset eye protection point in time.

In the embodiment, the set eye protection point in time is a preset point in time or the point in time that the accumulated fatigue duration of human eyes when the smart TV performs various operations exceeds a preset threshold.

Various operations in the smart TV may include: watching videos, playing games, browsing webpage, and viewing pictures, etc. According to various operations in the smart TV, different eye protection points in time may be preset, and the accumulated fatigue duration of human eyes of human eyes during various operations is a product of the duration when the smart TV performs various operations multiplying by fatigue factors of various operations.

Therefore, the different eye protection points in time are set by different operations in the smart TV, so as to be able to implement the more correct and scientific eye protection according to the actual conditions.

In the embodiment of the present disclosure, the total time of opening the human eyes is recorded by means of an external camera on the smart TV to estimate the degree of fatigue of human eyes.

In one embodiment of the present disclosure, the time of one day may be further performed time period division to implement the multi-mode eye protection.

The different eye protection points in time in different modes are set according to the above solution.

The eye protection unit 502 is configured to protect the eyes and suspend the current operation when the smart TV is suitable to protect the eyes at the eye protection point in time.

During the course of various operations, the current operation information of the smart TV needs to be acquired when achieving the preset eye protection point in time.

In the embodiment, the current operation information may include: a running time of the current operation or a running time of the current operation when starting in a new round, a rest end time of the current operation or a rest end time of the current operation after starting in a new round.

Further, when the smart TV is not suitable to protect the eyes at the eye protection point in time, a point in time suitable for eye protection is acquired according to the current operation information of the smart TV, and the eyes are protected and the current operation is suspended at the point time suitable for eye protection.

In the embodiment of the present disclosure, the eye protection unit is specifically configured to suspend the current operation of the smart TV; to perform an interactive operation between the smart TV and a cloud video server, so that the cloud video server pushes the related eye protection contents; to select the related eye protection contents pushed by the cloud video server by the smart TV, and return a selection result to the cloud video server, so that the cloud video server pushes the related eye protection contents pushed by the cloud video server and selected by the smart TV in the selection result via the cloud video server under a condition of the interactive operation between the smart TV and the cloud video server.

The step of performing the interactive operation between the smart TV and the cloud video server when protecting the eyes, so that the related eye protection content being pushed by the cloud video server may include: intelligently playing the music of eye exercises or playing teaching animation and other contents of the eye exercises. And the music name for selection may also be shown at this time. The related eye protection content pushed by the cloud video server is selected by the smart TV, and the selection result, for instance, the music name and the like, is returned to the cloud video server, so that the cloud video server pushes the related eye protection contents pushed by the cloud video server and selected by the smart TV in the selection result via the cloud video server under the condition of the interactive operation between the smart TV and the cloud video server. The related eye protection content is provided by the cloud video server and the selection result send by the intelligent TV is received by the cloud video server through the interactive operation between the smart TV and the cloud video server in the solution, so that the related eye protection content is rapid during the course of the later interactive operation between the smart TV and the cloud video server, which saves the time of the selection process.

Such contents like memo affairs and so on in the embodiment of the present disclosure may be performed according to the content preset by the user.

As the operation is performed during the course of the current operation, the current operation is continued after finishing, so as to enable the eye protection not to affect the process of the current operation.

According to the solutions above, the eye protection point in time is preset according to the actual conditions. When reaching the preset eye protection point in time, whether it is suitable to protect the eyes at the eye protection point in time needs to be further judged according to the current operation information of the smart TV, and the eyes are protected at the point in time when it is suitable to protect the eyes. Therefore, the inconvenience caused for the current operation of the smart TV when protecting the eyes is avoided by judging whether protecting the eyes according to the current operation information of the smart TV in the present disclosure. The related eye protection content is provided by the cloud video server and the selection result send by the intelligent TV is received by the cloud video server through the interactive operation between the smart TV and the cloud video server, so that the related eye protection content is rapid during the course of the later interactive operation between the smart TV and the cloud video server, which saves the time of the selection process.

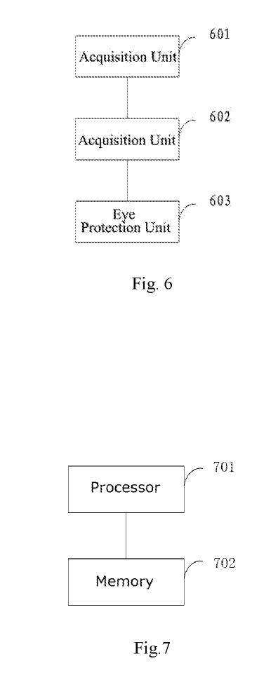

As shown in FIG. 6, the embodiment of the present disclosure further provides a smart TV. The smart TV includes an acquisition unit 601, an acquisition unit 602, and an eye protection unit 603.

The acquisition unit 601 is configured to acquire the information of the smart TV performing various operations.

The acquisition unit 602 is configured to acquire the accumulated fatigue duration of human eyes when the smart TV performs various operations according to the information of the smart TV performing various operations.

Various operations in the smart TV may include: watching videos, playing games, browsing webpage, and viewing pictures, etc. As various operations enable the degree of fatigue of human eyes to be different in the same time, the corresponding preset threshold needs to be set according to various operations in the smart TV.

The eye protection unit 603 is configured to protect the eyes and suspend the current operation at the point in time when the accumulated fatigue duration of human eyes exceeds the preset threshold if the accumulated fatigue duration of human eyes exceeds the preset threshold.

In the embodiment, the accumulated fatigue duration of human eyes of human eyes during various operations is a product of the duration when the smart TV performs various operations multiplying by fatigue factors of various operations.

The different eye protection points in time are set by different operations in the smart TV, so as to be able to implement the more correct and scientific eye protection according to the actual conditions.

In the embodiment of the present disclosure, the total time of opening the human eyes is recorded by means of an external camera on the smart TV to estimate the degree of fatigue of human eyes.

In one embodiment of the present disclosure, the time of one day may be further performed time period division to implement the multi-mode eye protection.

In the embodiment of the preset disclosure, the smart TV and the cloud video server perform the interactive operation when protecting the eyes, so that the related eye protection content is pushed by the cloud video server.

The related eye protection content pushed by the cloud video server is selected by the smart TV, and a selection result is returned to the cloud video server, so that the cloud video server pushes the related eye protection contents pushed by the cloud video server and selected by the smart TV in the selection result via the cloud video server under a condition of the interactive operation between the smart TV and the cloud video server.

For instance, the process of performing the interactive operation between the smart TV and the cloud video server, so that the related eye protection content being pushed by the cloud video server may include: intelligently playing the music of eye exercises or playing teaching animation and other contents of the eye exercises. And the music name for selection may also be shown at this time. The related eye protection content pushed by the cloud video server is selected by the smart TV, and the selection result, for instance, the music name and the like, is returned to the cloud video server, so that the cloud video server pushes the related eye protection contents pushed by the cloud video server and selected by the smart TV in the selection result via the cloud video server under the condition of the interactive operation between the smart TV and the cloud video server. The related eye protection content is provided by the cloud video server and the selection result send by the intelligent TV is received by the cloud video server through the interactive operation between the smart TV and the cloud video server in the solution, so that the related eye protection content is rapid during the course of the later interactive operation between the smart TV and the cloud video server, which saves the time of the selection process.

Such contents like memo affairs and so on in the embodiment of the present disclosure may be performed according to the content preset by the user.

As shown in FIG. 7, the embodiment of the present disclosure further provides a smart device. The smart device comprising:

a processor 701; and

a memory 702 adapted to store instructions executable by the processor 701;

wherein the processor 701 is configured to:

when reaching a preset eye protection point in time, determine whether the smart TV is suitable to protect eyes at the eye protection point in time according to current operation information of the smart TV; and when the smart TV is suitable to protect the eyes at the eye protection point in time, protect the eyes and suspend the current operation.

In one embodiment of the present disclosure, the processor 701 is configured to: the eye protection point in time is a preset point in time or the point in time that the accumulated fatigue duration of human eyes when the smart TV performs various operations exceeds a preset threshold.

In one embodiment of the present disclosure, the processor 701 is configured to: the accumulated fatigue duration of human eyes during various operations is a product of the duration when the smart TV performs various operations multiplying by fatigue factors of various operations.

In one embodiment of the present disclosure, the processor 701 is configured to: the current operation information further comprises: a running time of the current operation or a running time of the current operation when starting in a new round, a rest end time of the current operation or a rest end time of the current operation after starting in a new round; and various operations performed by the smart device further comprise a combination of one or more operations as follows: watching videos, playing games, browsing webpage, and viewing pictures.

In one embodiment of the present disclosure, the processor 701 is further configured to: acquire a point in time suitable for eye protection according to the current operation information of the smart device, and protect the eyes and suspending the current operation at the point time suitable for eye protection when the smart device is not suitable to protect the eyes at the eye protection point in time.

In one embodiment of the present disclosure, the processor 701 is further configured to: perform an interactive operation between the smart device and a cloud video server, so that the cloud video server pushes the related eye protection content; and the related eye protection content pushed by the cloud video server is selected by the smart device, and a selection result is returned to the cloud video server, so that the cloud video server pushes the related eye protection contents pushed by the cloud video server and selected by the smart device in the selection result via the cloud video server under a condition of the interactive operation between the smart device and the cloud video server.

In one embodiment of the present disclosure, the processor 701 is further configured to: continue the performance of the current operation after finishing the eye protection.

As the operation is performed during the course of the current operation, the current operation is continued after finishing, so as to enable the eye protection not to affect the process of the current operation.

According to the solutions above, the accumulated fatigue duration of human eyes when the smart TV performs various operations is acquired according to the information of various operations of the smart TV in the actual conditions. When the accumulated fatigue duration of human eyes exceeds the preset threshold, it illustrates that the human eye fatigue achieves a certain extent under which it is the best point in time to protect the eyes, so as to avoid causing inconvenience for the current operation of the smart TV when protecting the eyes.

Those ordinary skilled in the art may understand: all or part of steps of the above method embodiments may be finished by the hardware related to the program instruction. The foregoing program may be stored in a computer-readable storage medium. The program executes the steps including the above method embodiments during execution; and the foregoing storage medium includes any medium that is capable of storing program codes, such as a ROM, a RAM, a disk or an optical disk.

It should be finally noted that various embodiments above are merely employed to describe the technical solution of the present disclosure, but not limit thereto. Although the present disclosure is described in detail with reference to various embodiments above, those ordinary skilled in the art should understand: the technical solutions listed in various embodiments above may be stilled modified, or a part of or all technical features may be equivalently replaced; and these modifications or replacements do not enable the essence of the corresponding technical solution to depart from the scope of the technical solutions of various embodiments of the present disclosure.

1. An eye protection method based on a smart TV, comprising:
when reaching a preset eye protection point in time, determining whether the smart TV is suitable to protect eyes at the eye protection point in time according to current operation information of the smart TV; and
when the smart TV is suitable to protect the eyes at the eye protection point in time, protecting the eyes and suspending the current operation.

2. The method according to claim 1, wherein
the eye protection point in time is a preset point in time or the point in time that the accumulated fatigue duration of human eyes when the smart TV performs various operations exceeds a preset threshold.

3. The method according to claim 2, wherein
the accumulated fatigue duration of human eyes during various operations is a product of the duration when the smart TV performs various operations multiplying by fatigue factors of various operations.

4. The method according to claim 2, wherein
the current operation information further comprises: a running time of the current operation or a running time of the current operation when starting in a new round, a rest end time of the current operation or a rest end time of the current operation after starting in a new round; and
the various operations performed by the smart TV further comprise a combination of one or more operations as follows: watching videos, playing games, browsing webpage, and viewing pictures.

5. The eye protection method according to claim 1, wherein the method further comprises:
when the smart TV is not suitable to protect the eyes at the eye protection point in time, then acquiring a point in time suitable for eye protection according to the current operation information of the smart TV, and protecting the eyes and suspending the current operation at the point time suitable for eye protection.

6. The eye protection method according to claim 1, wherein further comprising:
performing an interactive operation between the smart TV and a cloud video server, so that the cloud video server pushing the related eye protection contents; and
selecting the related eye protection contents pushed by the cloud video server by the smart TV, and returning a selection result to the cloud video server, so that the cloud video server pushing the related eye protection contents pushed by the cloud video server and selected by the smart TV in the selection result via the cloud video server under a condition of the interactive operation between the smart TV and the cloud video server.

7. The eye protection method according to claim 1, further comprising after protecting the eyes and suspending the current operation:
continuing the performance of the current operation after finishing the eye protection.

8. A smart TV, comprising:
a determination unit, configured to, when reaching a preset eye protection point in time, determine whether the smart TV is suitable to protect eyes at the eye protection point in time according to current operation information of the smart TV; and
an eye protection unit, configured to, when the smart TV is suitable to protect the eyes at the eye protection point in time, protect the eyes and suspend the current operation.

9. The smart TV according to claim 8, wherein
the eye protection point in time is a preset point in time or the point in time that the accumulated fatigue duration of human eyes when the smart TV performs various operations exceeds a preset threshold.

10. The smart TV according to claim 9, wherein
the accumulated fatigue duration of human eyes during various operations is a product of the duration when the smart TV performs various operations multiplying by fatigue factors of various operations.

11. The smart TV according to claim 9, wherein
the current operation information further comprises: a running time of the current operation or a running time of the current operation when starting in a new round, a rest end time of the current operation or a rest end time of the current operation after starting in a new round; and
various operations performed by the smart TV further comprise a combination of one or more operations as follows: watching videos, playing games, browsing webpage, and viewing pictures.

12. The smart TV according to claim 8, wherein
the eye protection unit is further configured to acquire a point in time suitable for eye protection according to the current operation information of the smart TV, and protect the eyes and suspending the current operation at the point time suitable for eye protection when the smart TV is not suitable to protect the eyes at the eye protection point in time.

13. The smart TV according to claim 8, wherein
the eye protection unit is further configured to perform an interactive operation between the smart TV and a cloud video server, so that the cloud video server pushes the related eye protection content; and the related eye protection content pushed by the cloud video server is selected by the smart TV, and a selection result is returned to the cloud video server, so that the cloud video server pushes the related eye protection contents pushed by the cloud video server and selected by the smart TV in the selection result via the cloud video server under a condition of the interactive operation between the smart TV and the cloud video server.

14. The smart TV according to claim 8, wherein
the eye protection unit is further configured to continue the performance of the current operation after finishing the eye protection.

15. A smart device, comprising:
a processor; and
a memory adapted to store instructions executable by the processor;
wherein the processor is configured to:
when reaching a preset eye protection point in time, determine whether the smart TV is suitable to protect eyes at the eye protection point in time according to current operation information of the smart TV; and when the smart TV is suitable to protect the eyes at the eye protection point in time, protect the eyes and suspend the current operation.

16. The smart device according to claim 15, wherein the processor is configured to:
the eye protection point in time is a preset point in time or the point in time that the accumulated fatigue duration of human eyes when the smart TV performs various operations exceeds a preset threshold.

17. The smart device according to claim 16, wherein the processor is configured to:
the accumulated fatigue duration of human eyes during various operations is a product of the duration when the smart TV performs various operations multiplying by fatigue factors of various operations.

18. The smart device according to claim 16, wherein the processor is configured to:
the current operation information further comprises: a running time of the current operation or a running time of the current operation when starting in a new round, a rest end time of the current operation or a rest end time of the current operation after starting in a new round; and
various operations performed by the smart device further comprise a combination of one or more operations as follows: watching videos, playing games, browsing webpage, and viewing pictures.

19. The smart device according to claim 15, wherein the processor is further configured to:
acquire a point in time suitable for eye protection according to the current operation information of the smart device, and protect the eyes and suspending the current operation at the point time suitable for eye protection when the smart device is not suitable to protect the eyes at the eye protection point in time.

20. The smart device according to claim 15, wherein the processor is further configured to:
perform an interactive operation between the smart device and a cloud video server, so that the cloud video server pushes the related eye protection content; and the related eye protection content pushed by the cloud video server is selected by the smart device, and a selection result is returned to the cloud video server, so that the cloud video server pushes the related eye protection contents pushed by the cloud video server and selected by the smart device in the selection result via the cloud video server under a condition of the interactive operation between the smart device and the cloud video server.
